(19) United States
(12) Patent Application Publication
(10) Pub. No.: US 2009/0174769 A1
(43) Pub. Date: Jul. 9, 2009

(54) Surveillance Means

(76) Inventor: Elen Katz, Harutzim (IL)

Correspondence Address: Eckert Seamans Cherin & Mellott, LLC, U.S. Steel Tower, 600 Grant Street, 44th Floor, Pittsburgh, PA, 15219, US

(21) Appl. No.: 11/569,535

(22) PCT Filed: May 25, 2005
(86) PCT No.: PCT/IL05/00534

§ 371 Date: Nov. 22, 2006

Related U.S. Application Data
(60) Provisional application No. 60/574,623, filed on May 26, 2004.

(51) Int. Cl. H04N 7/18

(52) U.S. Cl. 348/143; 348/E07.085

(57) ABSTRACT

The present invention provides a unique surveillance means that comprises a rail through which electricity is being transferred as well as data. A movable-platform is adapted to move along the rail in relatively high speed. At least one supporting wheel and driving wheel are adapted to support and drive the platform on the rail using electricity that is delivered through the rail. Surveillance equipment is mounted on the platform and is adapted to transmit data in a secured manner through the rail. A control room is provided to control the transmission of electricity as well as information.

### FIELD OF THE INVENTION

The present invention relates to utilizing surveillance equipment. More particularly, the present invention relates to indoor or outdoor transportation of surveillance means such as camera and intelligent gathering information devices as well as the information itself.

This present application claims the benefit of an earlier US provisional patent application Ser. No. 60/574,623 filed on May 26, 2004 by Katz Ben and entitled “Surveillance means”.

### BACKGROUND OF THE INVENTION

Surveillance equipment using movable camera that can be moved on rail and record information taken from different areas is known in the art for many year. An example is disclosed in U.S. Pat. No. 4,699,484 “Rail mounted camera system” filed in 1985 by Howell et al. The patented camera system has a wheeled railed car with running gear front and back connected to a chassis. A panning head on top of the chassis has a motion picture camera mounted thereon and the rail car is self propelled. The car is movably installed on a track system consisting of rails connected together with ties, each rail having a power strip supplying electrical energy to the car through a set of wipers. An electrical control system is positioned remotely from the tracks and provides control for propulsion and positioning of the panning head as well as control of the camera. Another example is disclosed in U.S. Pat. No. 5,528,041 “Rail-based closed circuit T.V. surveillance system with automatic target acquisition” filed in 1994 by Glatt. In the rail-based closed-circuit T.V. surveillance system initialization is performed by positioning the surveillance camera at two different positions along the rail from which a target image is acquired, if the camera is within a range for viewing the target, target acquisition is occurs immediately while the camera is moved toward the optimum position. If the camera is not within the range for viewing the target, the camera is moved toward the viewing range. However, the speed in which the cameras move is very limited and the available equipment is mostly limited to indoor use or relatively small areas.

Attempts are made so as to increase the speed of the camera. An example is made on U.S. Pat. No. 4,777,527 “Moving video surveillance system” published in 1988 by Moudir et al. in which the surveillance system is displaceable inside a transportation tube along any direction in three-dimensional space under the effect of compressed fluid. The transportation tube is provided with at least one longitudinally-extending transparent observation window. The camera is contained in a displaceable “torpedo” and has its optical axis running parallel to the axis of the tube, and it receives images through the window by means of a mirror. Attempts were also made to improve the type of rail on which the carriage carrying the camera is mounted, for example—U.S. Pat. No. 4,337,482 “Surveillance system” filed in 1981 by Coutta, wherein a closed circuit T.V. surveillance system for business is provided with a TV camera movable along and suspended from a modified T shaped rail assembly that is housed in a partially opaque housing. Still, the speed of the camera in the predetermined path is relatively limited and is adapted for indoor uses. Moreover, in most cases, the information is recorded on a film available in the camera so that there is no on-line information available.

The use of a rail brought about additional uses of the tracks. For example, in U.S. Pat. No. 5,524,380 “Track mounted surveillance system having multiple use conductors” filed in 1991 by Benson et al., a pair of electrical conductors were mounted adjacent and parallel to the track. The conductors provide power to a drive assembly mounted on the carriage. Video cameras are mounted to the carriage for monitoring selected regions adjacent to the path. Output signals from the cameras are transmitted on the conductors to a remote monitoring location. Another option for using the track for electricity supply was filed by Patrick in 1999 and is disclosed in U.S. Pat. No. 8,339,448 “Cable-way mobile surveillance camera system”. In this patent, operational electrical power for moving the carriage and controlling the camera's movement are supplied via power lined connected at different polarities to the track cables of the track system.

Other means of transmitting the collected information are available and disclosed. BP patent no. 0554197 “Surveillance device with a mobile camera” that was published in 1993 by Bidault teaches a carriage or carriages that also carry at least one laser transmitted that transmits the video signal from the camera in real time to at least one fixed laser receiver. In another example that is disclosed in FR patent no. 2,722,927 “Data transmission system e.g. for CCTV surveillance” by Gouspillou. The disclosed system includes a fixed antenna that is elongated and a mobile antenna that is formed from a shorter length of tubing surrounding the fixed antenna. A transceiver transmits HF signals to the antenna that, are modulated by the video signal and modulates incoming camera control signals. The collected information in the above mentioned systems as well as available systems is transmitted in a relatively poor quality and cannot transmit clear pictures when the camera is moving in high speeds. Moreover, these systems as well as other systems are exposed to data manipulation or theft.

### SUMMARY OF THE INVENTION

It is an object of the present invention to provide surveillance means in which the camera can be moved in a relatively high speed for long distances in order to cover large areas.

It is another object of the present invention to provide a surveillance means in which the surveillance equipment provides on-line information from the covered area so as to allow a user to steer the equipment from a distant location according to the information acquired on-line.

It is yet another object of the present invention to provide a surveillance means adapted for outdoor as well as indoor and can operate while providing valuable information in very harsh conditions.

Another object of the present invention is to provide a surveillance means that can be programmed so as to record information in a predetermined path and time frames.

An additional object of the present invention is to provide a surveillance means in which information is adapted to be transferred in a closed system rather than transmitted by wireless means so as to prevent the inappropriate manipulation of the system as well as theft. The information can be on-line recorded on a computer that is available in a distant location. The surveillance means of the present invention is highly secured relative to existing means of data transferring.

Therefore, there is provided in accordance with a preferred embodiment of the present invention a surveillance means comprising:
a rail provided with a conductor rail adapted to supply electricity through said rail and a data rail adapted to transmit data;
a movable platform adapted to move along said rail;
at least one wheel adapted to support said platform;
at least one wheel adapted to drive said platform by means of electricity delivered through said conductor rail;
surveillance equipment mounted on said platform and adapted to transmit data through said data rail;
a controller adapted to control the movement of said platform on said rail as well as control the transmission of information.

Furthermore, in accordance with another preferred embodiment: of the present invention, said movable platform is provided with a mini antennae adapted to move along said data rail wherein said mini antennae is adapted to transmit data from and to said computerized controller.

Furthermore, in accordance with another preferred embodiment of the present invention, said data rail transmits data by using microwave technology.

Furthermore, in accordance with another preferred embodiment of the present invention, said conductor rail is made of coated copper.

Furthermore, in accordance with another preferred embodiment of the present invention, said at least one wheel adapted to drive on said rail is connected to engine unit adapted to rotate the wheel and wherein said engine unit is adapted to receive electricity from said conductor rail through a power control unit.

Furthermore, in accordance with another preferred embodiment of the present invention, power collectors that are engaged with said conductor rail collect power from said conductor rail and delivers the power to said power control unit.

Furthermore, in accordance with another preferred embodiment of the present invention, said power collectors are made of coal.

Furthermore, in accordance with another preferred embodiment of the present invention, said rail is a monorail having a strip profile that connects two cylindrical bands adapted to support said at least one wheel.

Furthermore, in accordance with another preferred embodiment of the present invention, said at least one wheel comprises two pairs of supporting wheels, each one is supported on one of said two cylindrical bands and a driving wheel that is supported on one of said two cylindrical bands.

Furthermore, in accordance with another preferred embodiment of the present invention, said movable platform is adapted to reach a velocity of about 90 km/h.

Furthermore, in accordance, with another preferred embodiment of the present invention, said movable platform comprises a housing that houses said at least one wheel and a supporting base onto which said surveillance equipment is mounted.

Furthermore, in accordance with another preferred embodiment of the present invention, said supporting base is mounted on said housing through a stabilizing system.

Furthermore, in accordance with another preferred embodiment of the present invention, said supporting base is provided with a protective transparent cover.

Furthermore, in accordance with another preferred embodiment of the present invention, said controller is provided within a control room that is provided in the vicinity of said surveillance means.

Furthermore, in accordance with another preferred embodiment of the present invention, said data transferred from said surveillance equipment is digital data.

Furthermore, in accordance with another preferred embodiment of the present invention, said controller is provided with a predetermined plan by which said movable platform moves in a predetermined path.

Furthermore, in accordance with another preferred embodiment of the present invention, said controller is provided with a predetermined plan by which said surveillance equipment is operated.

Furthermore, in accordance with another preferred embodiment of the present invention, the surveillance means is further provided with a garage adjacent said rail and wherein said movable platform can be stored or maintained within said garage.

Furthermore, in accordance with another preferred embodiment of the present invention, the surveillance means is provided with a power supply adapted to supply power for electricity to said conductor rail.

Additionally and in accordance with another preferred embodiment of the present invention, said surveillance equipment comprises a camera.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates surveillance means apparatus in accordance with a preferred embodiment of the present invention.

FIG. 2 illustrates a cross sectional view of a platform mounted on a rail in accordance with a preferred embodiment of the present invention.

### DETAILED DESCRIPTION OF THE INVENTION AND FIGURES

The use of surveillance means extends to many applications. The present invention is aimed at providing a new and unique surveillance means by which the surveillance equipment is conveyed at high speed to a distant location in an outdoor or indoor environment while providing on-line information from the area that is being covered by the surveillance means. The main feature of the surveillance means of the present invention is the ability of the conveyor to drive the surveillance equipment that is installed on it in relatively high speed while acquiring high quality information even in harsh conditions.

The surveillance means of the present invention comprises a rail which is preferably a monorail, a platform onto which the surveillance equipment is being mounted, and a control room from which the movement of the platform on the rail is being controlled and monitored. The monorail, further of being the conveyor of the platform, transfers electricity to the platform and data from it while the whole combination is being controlled from the control room.

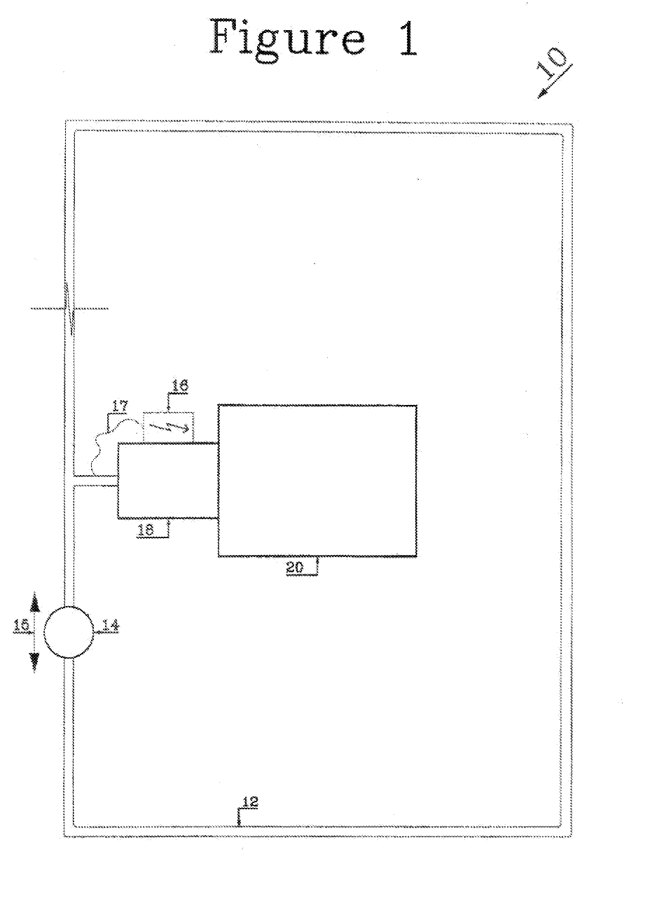

Reference is now made to FIG. 1 illustrating surveillance means apparatus in accordance with a preferred embodiment of the present invention. Surveillance means 10 is mainly based on a photographing apparatus that can cover areas to the extent of about 5 km in its length while there is a possibility to form several sections, each of such as extent. The sections can be put together to cover hundreds of kilometers. Surveillance means 10 comprises a rail 12, which is preferably a monorail that can be organized as a round rail as shown in FIG. 1. The apparatus can be organized in any other structure that by no means limits the scope of the present invention. For example, the rail can be an elongated rail having a path that correspond physical features of the area that needs to be covered by photography. The rail can be mounted on supporting poles, suspend of poles, close to the ground, or adjacent to other structures. Rail 12 is adapted to convey a driven platform as well as transferring electricity and data as will be elaborated herein after.

Surveillance means 10 further comprises a movable platform 14 that is mounted on rail 12 and is driven on the rail to any desired direction as shown by arrow 15. Surveillance equipment is installed on platform 14 that is adapted to drive in relatively high speed on rail 12. Platform 14 can be steered from a distance and will be mainly directed from a control room 20 that can be located adjacent to the rail or in any other distant location.

As mentioned herein before, rail 12 is adapted to transport electricity; therefore is electrically connected to a power supply 16 by wires 17 that provide electricity to the rail so as to enable movable platform 14 to move on rail 12.

Surveillance apparatus 10 is preferably and further comprise a garage 18 into which rail 12 extends. Platform 14 can be stored in garage 18 when not in use or brought in for maintenance. Control room 20 is provided with means (not shown in the figures) for steering platform 14 and maneuvering the means for collecting data that is usually provided on the platform. Steering and maneuvering the platform and the surveillance equipment can be performed by available computerized controlling means and can be maintained using a joystick, for example. The computerized controlling means that is provided in control room 20 can be connected in various manners to the remote operators.

Optionally, the apparatus can be provided with different precaution means such as means that automatically takes control on the system if the user gives an order that is not compatible with current conditions in the field or there is an attempt to fake control by other parties over the surveillance means.

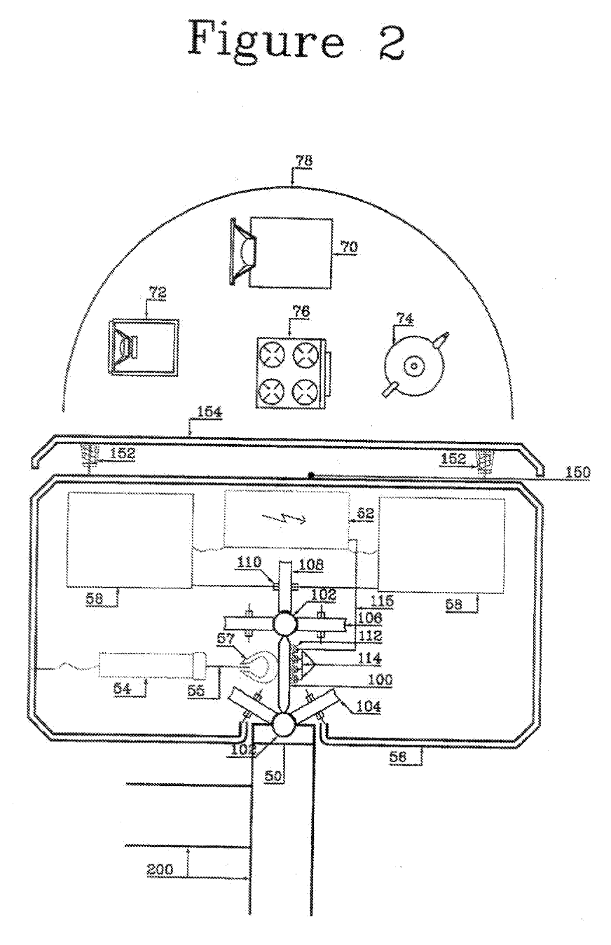

Reference is now made to FIG. 2 illustrating a cross sectional view of a platform mounted on a rail in accordance with a preferred embodiment of the present invention. Monorail 50 has preferably a profile of a strip 100 having cylindrical band 102 on both ends. Both cylindrical bands 10 are adapted to support and carry two pairs of supporting wheels 104 and 108, each pair is supported on each cylindrical band 100. A running wheel 108 is provided to monorail 50, and supported on one of the cylindrical bands. Running wheel 108 is provided with an axis 110 that is connected to preferably two engine units 58 that are adapted to rotate and drive running wheel 108 on the rail. Monorail 50 is preferably made of a metallic material adapted to uphold the loads that are formed when the wheels are driven through the monorail carrying the platform as will be explained herein after. Monorail 50 can be supported by a support 200.

One pair of supporting wheels 104 supports also a housing 56 that acts as a platform onto which surveillance equipment is mounted. One side of strip 100 is provided with a conductor rail 112 preferably made of coated copper. Power collectors 114 that are provided in housing 56 are preferably made of coal and are sliding within conductor rail 112. Power collectors 114 are electrically connected to a power control unit 52 that is adapted to receive electricity from the power supply that is shown in FIG. 1 (the power supply unit is not shown in FIG. 2). Power collectors 114 are adapted to collect the power from conductor rail 112 and transfer if through wire 115 to power control unit 52 and engine unit 58 so as to actuate running wheel 108. Conductor rail 112 that is adjacent to strip 100 prevents the use of electricity cables that usually entangles the system and forms a cumbersome system.

The other side of monorail 50 is provided with a no-contact data rail 57 adapted for transporting of data. A mini antenna 55 is provided adjacent to data rail 57 and preferably within the data rail; however, mini antennae 55 has no physical connection with data rail 57. Mini antenna 55 is provided within housing 58 and is driven within data rail 57. Data is transported within data rail 57 using microwave technology such as the technology manufactured by the Vhale company in Germany. Mini antennae 55 is communicating with data rail 57 and transfers information in an outstanding rate of substantially 10 root/sec. This provides the ability to transfer orders from the control room (shown in FIG. 1) to the equipment installed on the platform and to deliver video pictures taken from the covered area in which the platform is driven, back to the control room in very high quality.

This preferable manner of information transportation is secured against data theft and enables encoding the information and protecting it from unwanted entities. Transferring information in a closed system rather than transferring it in a wireless transmission means such as means described in prior art provides data protection. Wireless transmission nowadays is a method that can be easily decoded and unwanted users can use the information. Moreover, wireless transmission can be disrupted and disturbed.

Optionally, the system is provided with backup data transportation system that can use wireless technologies such as Canopy Motorola wireless communication system that is operable in case a fault in the main data transportation system.

It should be mentioned that the unique monorail used in the present invention is a heavy-duty rail that can be used indoor or outdoor without considering weather or other physical features. Constructing the rail on an available basis such as earth (sand; concrete; road; grass etc.), buildings, roofs, fences, wails, bridges, supporting elements such as electricity poles and any other construction is possible. The moving platform is mounted on the monorail and can be conveyed in tremendous speeds while developing high toads without affecting the performance of the system. The speed of the platform can reach velocities of about 90 km/h. For that reason and unique feature, manned patrols can be replaced by the apparatus of the present invention. Since the moving platform is connected to a computerized control room, the path of the platform can be programmed in an autopilot manner so as to tour the rail in a predetermined path.

As mentioned herein before, housing 56 acts as a moving platform onto which surveillance equipment can be mounted. Housing 56 is preferably provided with a stabilizing system 150 that can comprise springs units 152 onto which, a supporting base 154 is provided. Supporting base 154 is designed to have a relatively small area (1 m×1 m, for example) so as to allow its movement in small area and in the desired speed.

Surveillance equipment is mounted on supporting base 154. The equipment can be changed in accordance with the purpose and application of using the surveillance system. Surveillance equipment can comprise elementary equipment such as a camera 70; however, it can be provided with speaker 72, electronic devices 74, and other intelligence gathering devices 76. Other devices such as announcement system, high duty spotlight, microphone, weapons, radar, GPS system and other systems that are appropriate to the purpose of surveillance can be utilized and mounted on supporting base 154 or in any other position on the moving platform.

A protective transparent cover 78 is installed onto supporting base 154 so as to protect the equipment against weather and aggressive sabotage by unwanted parties.

Camera 70 can be an available camera that on-line transmits pictures or a video camera. Controlling the camera is maintained by a user in the control room as shown in FIG. 1 using a remote control based on a microwave transmitting technology, as mentioned herein before. Thermo cameras or infrared camera can be used while attaining photographs in harsh conditions such as at night or in harsh weather. Other surveillance equipment can be provided to the camera so as to enable other surveillance features. Supporting units can be provided to camera 70 so as to enable its stability while photographing takes place.

As mentioned herein before, mini antenna 55 communicated with data rail 57 so as to transmit information back and forth. Mini antenna 55 is electronically connected by electronic means 54 to housing 58 so as to receive data from the surveillance equipment that is mounted on the platform and deliver it to the control room through the rail. Electronic means 54 also delivers orders from the control room to surveillance equipment or to the power control unit so as to control the movement of the platform on the rail.

It is preferable that the information attained by the camera is recorded in a digital manner on a computer so as to avoid using recording tapes so that hours of photographic material can be gathered and can be digitally decoded. This provides the ability to find information recorded in a specific date and hour in an immediate manner without having to go through recording tapes.

It should be mentioned that the means of transferring the information using microwave technology is brought herein as an example. Other means can be used in the system of the present invention without limiting the scope of the present invention.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A surveillance means comprising:
a rail provided with a conductor rail adapted to supply electricity through said rail and a data rail adapted to transmit data;
a movable platform adapted to move along said rail;
at least one wheel adapted to support said platform;
at least one wheel adapted to drive said platform by means of electricity delivered through said conductor rail;
surveillance equipment mounted on said platform and adapted to transmit data through said data rail;
a controller adapted to control the movement of said platform on said rail as well as control the transmission of information.

2. The surveillance means as claimed in claim 1, wherein said movable platform is provided with a mini antennae adapted to move along said data rail wherein said mini antennae is adapted to transmit data from and to said computerized controller.

3. The surveillance means as claimed in claim 1, wherein said data rail transmits data by using microwave technology.

4. The surveillance means as claimed in claim 1, wherein said conductor rail is made of coated copper.

5. The surveillance means as claimed in claim 1, wherein said at least one wheel adapted to drive on said rail is connected to engine unit adapted to rotate the wheel and wherein said engine unit is adapted to receive electricity from said conductor rail through a power control unit.

6. The surveillance means as claimed in claim 5, wherein power collectors that are engaged with said conductor rail collect power from said conductor rail and delivers the power to said power control unit.

7. The surveillance means as claimed in claim 6, wherein said power collectors are made of coal.

8. The surveillance means as claimed in claim 1, wherein said rail is a monorail having a strip profile that connects two cylindrical bands adapted to support, said at least one wheel.

9. The surveillance means as claimed in claim 5, wherein said at least one wheel comprises two pairs of supporting wheels, each one is supported on one of said two cylindrical bands and a driving wheel that is supported on one of said two cylindrical bands.

10. The surveillance means as claimed in claim 1, wherein said movable platform is adapted to reach a velocity of about 90 km/h.

11. The surveillance means as claimed in claim 1, wherein said movable platform comprises a housing that houses said at least one wheel and a supporting base onto which said surveillance equipment is mounted.

12. The surveillance means as claimed in claim 11, wherein said supporting base is mounted on said housing through a stabilizing system.

13. The surveillance means as claimed in claim 11, wherein said supporting base is provided with a protective transparent cover.

14. The surveillance means as claimed in claim 1, wherein said controller is provided within a control room that is provided in the vicinity of said surveillance means.

15. The surveillance means as claimed in claim 1, wherein said data transferred from said surveillance equipment is digital data.

16. The surveillance means as claimed in claim 1, wherein said controller is provided with a predetermined plan by which said movable platform moves in a predetermined path.

17. The surveillance means as claimed in claim 1, wherein said controller is provided with a predetermined plan by which said surveillance equipment is operated.

18. The surveillance means as claimed in claim 1, wherein the surveillance means is further provided with a garage adjacent said rail and wherein said movable platform can be stored or maintained within said garage.

19. The surveillance means as claimed in claim 1, wherein the surveillance means is provided with a power supply adapted to supply power for electricity to said conductor rail.

20. The surveillance means as claimed in claim 1, wherein said surveillance equipment comprises a camera.
